(19) United States
(12) Patent Application Publication
(10) Pub. No.: US 2006/0042961 A1
(43) Pub. Date: Mar. 2, 2006

(54) Potentiometric measurement of chloride concentration in an acidic solution

(76) Inventor: Xihai Mu, Chino Hills, CA (US)

Correspondence Address: SHELDON & MAK, INC, 225 SOUTH LAKE AVENUE, 9TH FLOOR, PASADENA, CA, 91101, US

(21) Appl. No.: 10/931,096

(22) Filed: Aug. 30, 2004

(51) Int. Cl. G01N 27/26; G01F 1/64

(52) U.S. Cl. 205/775; 204/416

(57) ABSTRACT

Measuring chloride ions in a sample solution at acidic pH with a potentiometric silver chloride electrode is disclosed.

### BACKGROUND

Ion selective electrodes are used to measure the concentration of a particular ion in a solution. They are widely used in biomedical research and clinical testing, among other applications. In the diagnostic area, ion selective electrodes are used to measure ion concentrations in blood, serum, plasma, cerebrospinal fluid, urine and other clinical samples. Chloride ion levels in bodily fluids, for example, are characteristic of certain electrolyte and metabolic disorders including cystic fibrosis. Measuring chloride ions can therefore aid in the diagnosis and treatment of such conditions.

Ion selective electrodes are subject to erosion and degradation over time, however, due to chemical interactions with samples and reagents, resulting in sluggish kinetic response and voltage drift. Ion selective electrodes need to be recalibrated periodically, sometimes daily, due to electrode surface variation caused by such erosion, and they eventually need to be replaced.

### SUMMARY

The present invention provides an improved method of measuring the concentration of chloride ions in a sample solution which initially has a pH greater than 5, such as a solution comprising a clinical sample. The method comprises the steps of adding an acidic reagent to the sample solution to lower its pH to 5 or less, and contacting this acidified sample solution with an ion sensitive electrode comprising silver chloride (either sequentially or simultaneously). The electric potential of the acidified sample solution is then measured with the electrode, which experiences less surface degradation as a result of exposure to the acidified solution compared with exposure to a solution at higher pH. The measured electric potential is preferably converted into chloride concentration for convenience. The pH of the sample is preferably lowered to less than about 4, and more preferably to less than about 3, such as to about 2.5. The electrode used in this method is preferably a solid state silver chloride electrode.

In another aspect, the present invention provides a method of measuring the concentration of chloride ions in a clinical sample, comprising the steps of obtaining a solution between about pH 6 and 8 that includes the clinical sample; adding an acidic reagent to the solution to lower its pH to 5 or less; contacting the acidified solution with an ion sensitive electrode comprising silver chloride; and then measuring the electric potential of the acidified solution with the electrode. The measured electric potential is likewise preferably converted into chloride concentration information. In addition, the pH of the solution being measured is preferably lowered to less than about 4, and more preferably to about 2.5.

In a further aspect, the present invention provides a method of measuring the concentration of chloride ions in a plurality of sample solutions by contacting one of the sample solutions with an ion selective electrode comprising silver chloride, measuring the electric potential of the sample solution with the electrode, removing the sample solution, contacting the electrode with one or more buffer solutions, and then repeating these steps for each of the remaining sample solutions over a period of more than 2 months. Over this period, substantially all of the sample solutions and buffer solutions in contact with the electrode are at a pH of 5 or less according to this method, so that the electrode decreases in sensitivity by less than 30 percent. The sensitivity of the electrode can drop by less than 30 percent over a period of 4 months or more. The electrode is preferably replaced after a drop in sensitivity of 30 percent or greater is detected, and more preferably is replaced if a drop in sensitivity of 20 percent or more is detected. In addition, if one or more of the sample solutions initially has a pH greater than 5, the pH of such solutions is lowered to pH 5 or less.

In yet another aspect, the present invention provides a method of operating an ion selective electrode comprising silver chloride, comprising the steps of calibrating the electrode, measuring chloride concentration in one or more sample solutions having a pH of 5 or less with the electrode, and then evaluating the calibration of the electrode after more than 3 days. By maintaining the electrode in substantially continuous contact with sample solutions and buffer solutions having a pH of 5 or less for a period of more than 3 days, the frequency of electrode calibration is lessened. A concentration measurement of a solution of known chloride concentration obtained by the electrode will differ by less than about 3 percent from the known chloride concentration of the solution after three days. Calibrating the electrode initially can be accomplished by contacting the electrode with a solution having a known chloride concentration, obtaining a voltage measurement (corresponding to chloride concentration) with the electrode, and then adjusting the electrode so that the measured chloride concentration corresponds to the known chloride concentration of the solution. If one or more of the sample solutions initially has a pH greater than 5, the pH of such solutions is lowered to a pH of 5 or less. The electrode can be in substantially continuous contact with the sample solutions and buffer solutions for a period of more than 5 days, during which time the concentration of a solution of known chloride concentration measured by the electrode changes by less than about 3 percent.

Another aspect of the invention comprises a method for measuring the concentration of ions in a sample solution with an analytical instrument having a plurality of ion selective electrodes. In this method, a sample solution at a pH greater than 5 is placed in contact with an ion selective electrode in the instrument which is adapted to measure the electric potential of an ionic species in the solution other than chloride, such as sodium, potassium, lithium, or calcium, and this ion selective electrode then measures the electric potential of the sample solution. In order to measure the concentration of chloride in the sample solution, the pH of the sample solution is lowered to 5 or less, and this acidified sample solution is then contacted with a silver chloride electrode in the instrument, which measures the electric potential of the acidified solution. This potential measurement is preferably converted into chloride concentration information. The pH of the sample is preferably lowered to less than about 4, and more preferably to about 2.5.

A further aspect of the invention comprises a system for measuring the concentration of chloride ions in a sample solution. The system includes a first container for holding the sample solution and an ion selective electrode adapted to measure the electric potential of an ionic species in the sample solution other than chloride, which is in communication with the first container. An ion selective electrode comprising silver chloride is positioned in a second container, and a duct is provided for conducting the sample solution from the first container to the second container. In addition, the system includes a container for holding an acidic reagent, and another duct for conducting the acidic reagent either to the first duct or to the second container.

### DRAWINGS

These and other features, aspects and advantages of the present invention will become better understood with regard to the following description, appended claims, and accompanying figures where:

FIG. 1 is a graph showing the electrode kinetic response of the silver chloride electrode of a SYNCHRON LX20 clinical analyzer versus time for two sample solutions having different chloride concentrations at three different pH levels.

FIG. 2 is a graph showing voltage measurement with the silver chloride electrode of a SYNCHRON CX3 clinical analyzer versus time for three sample solutions having different concentrations of chloride.

FIG. 3 is a graph which depicts the linearity of chloride measurements taken with the silver chloride electrode of a SYNCHRON CX3 clinical analyzer at pH 2.5 and at pH 7.0.

FIG. 4 is a graph showing the voltage output of the silver chloride electrode of a SYNCHRON CX3 clinical analyzer measuring two sample solutions with different chloride concentrations at pH 2.5 over a 60 day period.

FIG. 5 is a graph showing chloride ion measurements of three sample solutions at pH 2.5 over a 60 day period using the silver chloride electrode of a SYNCHRON CX3 clinical analyzer.

FIG. 6 illustrates a flow cell design which includes a silver chloride electrode for measuring chloride concentration at low pH and other electrodes for measuring the concentration of other ions at neutral pH.

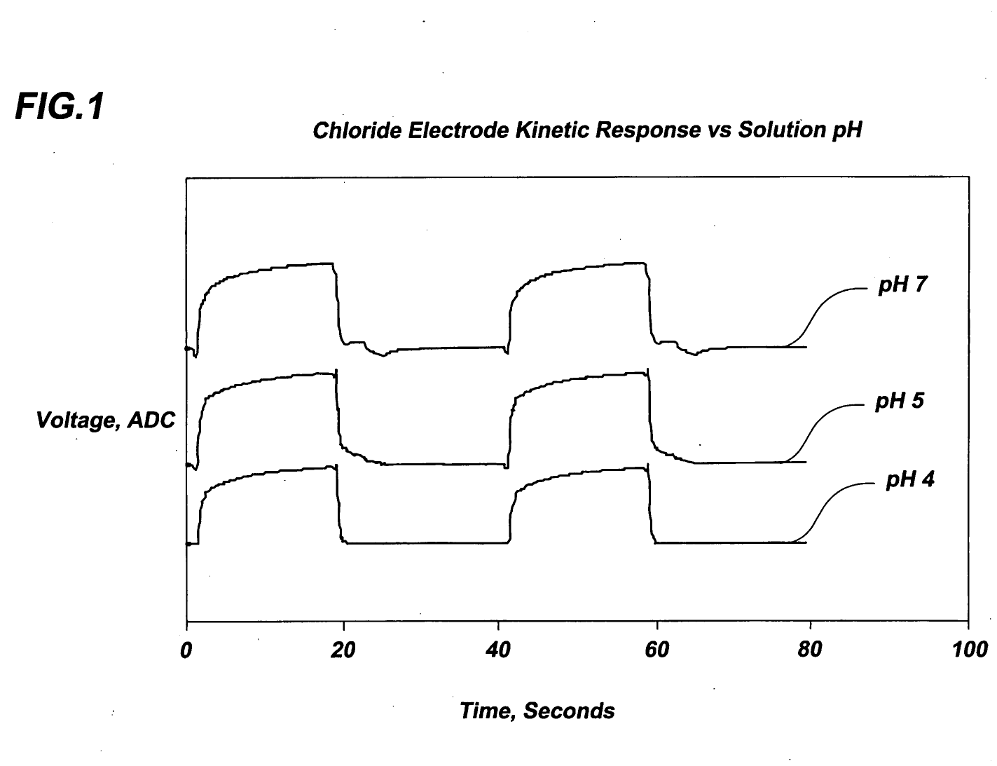

ADC, or analog to digital conversion, as used in FIGS. 1, 3 and 4 is a voltage measurement on Beckman's SYNCHRON systems which represents the voltage multiplied by a gain factor. All dimensions specified in this disclosure are by way of example only and are not intended to be limiting. Further, the proportions shown in these Figures are not necessarily to scale. As will be understood by those with skill in the art with reference to this disclosure, the actual dimensions of any device or part of a device disclosed in this disclosure will be determined by their intended use.

### DESCRIPTION OF THE INVENTION

The present invention provides a method for measuring the concentration of chloride ions in a sample solution using a silver chloride electrode. Chloride concentration is typically measured at a pH of between about 7 and 8, particularly when the samples to be measured are clinical samples. “Clinical samples” as used herein refer to samples comprising biological material, in particular liquid or tissue samples from a human or animal subject such as blood, serum, plasma, cerebrospinal fluid, and urine. In the present method, the pH of such samples is lowered to about 5 or less, so that contact between such samples and a silver chloride electrode results in less electrode surface erosion and/or less chemical interference in assays performed with the electrode. The frequency of electrode recalibration is also thereby greatly reduced, as is the frequency of electrode replacement (i.e., electrode longevity is increased). Silver chloride electrodes operated at low pH also exhibit fast kinetic response, high sensitivity, good linearity and precision, and stable voltage output.

Electrodes

Silver chloride electrodes are well known to the art. As used herein, the term “silver chloride electrode” refers to an ion sensitive electrode comprising silver chloride (AgCl) which is adapted to measure the electric potential of a solution corresponding to the concentration of chloride ions in the solution. Silver chloride electrodes can comprise, for example, a silver substrate coated with silver chloride. Such electrodes can be formed from a piece of silver wire coated with silver chloride, such as through electroplating or through exposure of the silver substrate to bleach. The coated surface is adapted to contact a solution which is to be measured for chloride concentration, while the silver core is in electrical communication with a potentiometer or voltmeter and with a reference electrode.

Silver chloride electrodes can also be solid state electrodes, which typically comprise a pellet including crystals or granules of silver chloride combined with other additives. Solid state silver chloride electrodes are described in U.S. Pat. No. 5,552,032 to Xie (the contents of which are hereby incorporated by reference). Such solid state electrodes comprise a mixture of AgCl and other additives, forming an AgCl mixture. Preferably, such solid state silver chloride electrodes do not include metallic silver or include only a relatively small amount of silver, as it has been found that the presence of metallic silver in a solid state silver chloride electrode can cause voltage drift in electrode measurements over a period of time. The AgCl mixture of a solid state silver chloride electrode preferably comprises more than 50% AgCl, and more preferably from about 95% to about 99.5% AgCl.

Other silver chloride electrodes known to the art can also be used in the present methods. For example, an ISFET (ion-sensitive field effect transistor) type electrode (microsensor) comprising a layer of AgCl can be used.

Any reference electrode known to the art which has a stable, well-defined electrochemical potential can be used in the present method. Such reference electrodes include silver/silver chloride and saturated calomel (SCE) reference electrodes.

Measuring Chloride Concentrations at Acidic pH

To measure the chloride concentration of a sample solution with a silver chloride electrode, the silver chloride electrode is placed in contact with the sample solution, and an electrical potential is developed between the silver chloride electrode and a reference electrode which is in electrical communication with the silver chloride electrode. By measuring this potential, the concentration of chloride in the solution can be determined. Both the silver chloride electrode and reference electrode are electrically connected to a device for measuring the potential difference between the silver chloride electrode and the reference electrode, such as a potentiometer or voltmeter. The device displays and preferably also records the measured voltage or potential difference between the silver chloride electrode and the reference electrode (generally expressed in millivolts), and also preferably displays and/or records the measurements in chloride ion concentration units.

Chloride concentration is measured according to the present method at a pH of 5 or less, preferably at a pH of about 4 or less, and more preferably at a pH of between 2 and 3. If a sample solution is initially at a pH greater than 5, then it is treated to reduce the pH of the solution, such as through the addition of an acidic reagent. Since clinical samples typically have pH values between about 7 and 8, the pH of such samples is therefore adjusted in the present method. Preferably, an appropriate amount of a reagent comprising a strong acid such as phosphoric acid, nitric acid, or sulfuric acid is mixed with a sample to be measured in order to adjust its pH.

Lowering the pH of the sample solution is believed to have the beneficial effect of reducing the number of ionic species present in the solution which are capable of interacting with Ag⁺ in a silver chloride electrode. For example, tris(hydroxymethyl)-aminomethane (TRIS), a commonly used buffer material, can interact with Ag⁺ at pH 7 or higher, but at lower pH levels exists primarily as its conjugate acid [TRISH]⁺ and interacts much more weakly with Ag⁺. It is believed that the weaker interaction of such species with the surface of an AgCl electrode at low pH levels causes changes in the surface of the electrode related to such interaction (e.g., degradation) to occur more slowly, thus resulting in greater longevity of AgCl-based electrodes and reducing the frequency of both electrode recalibration and electrode replacement. Such electrodes also experience improved kinetic response, sensitivity, linearity and precision.

The benefits of measuring chloride concentrations at lower pH with a silver chloride electrode are apparent at pH 5, but are even greater at pH 4 or less. This can be seen in FIG. 1, which shows two solutions containing different chloride concentrations passing across the surface of an AgCl electrode in a SYNCHRON LX20 clinical analyzer (i.e., two measurement cycles). The kinetic response of the electrode was markedly faster at pH 5 compared with pH 7, and even faster at pH 4. At pH 5, the voltage reading approached steady state more smoothly than at pH 7, while at pH 4 steady state was reached almost immediately (within a second or two). Testing sample solutions at a pH of 5 or less is therefore preferred in the present invention, while pH values of 4 or less, such as pH 3.5, are even more preferred. The advantages of testing samples at pH 3 or less, particularly at pH 2.5, are described in the examples below.

A silver chloride electrode can be brought into contact with an acidic sample solution according to the present method in a number of ways. For example, an electrode can be physically contacted with such an acidic sample solution, or a sample solution over pH 5 can alternatively be acidified as it comes into contact with the electrode (simultaneously with contact or just after contact). In a preferred embodiment, a sample solution having a pH of less than about 5 is brought into contact with a silver chloride electrode, and after the electric potential of the sample solution is measured with the electrode the sample solution is removed, i.e. it is no longer in contact with the electrode. The electrode is then placed in contact with one or more buffer solutions having a pH of about 5 or less. In order to measure a further sample, the buffer solution in contact with the electrode is removed, and the further sample is placed in contact with the electrode. It is to be understood that in place of adding or removing solutions to a container comprising a silver chloride electrode, the electrode can alternatively be moved to containers holding such solutions.

It has surprisingly been found that silver chloride electrodes in contact with sample solutions and buffers having a pH of about 5 or less have a useful life of more than 2 months, and often of more than 4 months or 6 months when such electrodes are in contact with these solutions. “Contact” in this context refers to the period of time that the surface or surfaces of an electrode are in physical contact with one or more solutions, disregarding the amount of time such surfaces are not in contact with a solution, such as when the surface is dry. Silver chloride electrodes are preferably in substantially continuous contact with solutions having a pH of about 5 or less, i.e. they are in contact with such solutions for 70% or more of the time that they are in contact with any solution. Preferably such electrodes are in contact with such low pH solutions for 90% or more of the time. When a plurality of clinical samples are being assayed with a silver chloride electrode, it is preferred that substantially all of the sample solutions and buffer solutions used in such evaluations be maintained at a pH of 5 or less, i.e. that 70% or more of the solutions, and preferably 90% or more, be at pH 5 or less.

Although it is possible for silver chloride electrodes to be dried between measurements, it is preferred that such electrodes be in contact with a solution substantially constantly once put into service. If a silver chloride electrode is dried, such as during maintenance, it will need to be placed back into contact with a solution and allowed to stabilize for a period of hours (sometimes overnight) prior to being able to render accurate chloride concentration measurements. Therefore, in commercial applications substantially constant contact between the electrode and some solution or solutions (i.e. contact for preferably greater than 90% of the time) after the electrode is placed into service is preferred.

The end of an electrode's useful life, i.e. the point at which it should be replaced, can be determined by evaluating the sensitivity of the electrode. Replacement of a silver chloride electrode is generally indicated when the sensitivity of such an electrode decreases by about 30 percent or more. Such electrodes are more preferably replaced when their sensitivity declines by about 20 percent or more. Sensitivity in this context can be determined by (1) measuring the voltage difference between two solutions having different concentrations of chloride at a time point, (2) measuring the voltage difference between the same two solutions at a later point, and (3) comparing the change in the voltage span between the two solutions (i.e. the change in the measured voltage between the two solutions).

The following procedure can be used to determine the sensitivity of a silver chloride electrode. Two solutions having chloride concentrations of, for example, 50 mmol/L and 100 mmol/L respectively are provided, and the voltage span between these solutions is measured when a new AgCl electrode is installed, e.g. into a Synchron CX3 clinical analyzer. The voltage span is then measured again, e.g., two months later. If the first measurement is 1000 ADC and the second is 700 ADC, this would represent a drop in sensitivity of 30%.

When a silver chloride electrode is in substantially continuous contact with a solution at a pH of 5 or less, the frequency of recalibration can be reduced from daily recalibration, as is generally required for silver chloride electrodes used with higher pH solutions, to recalibration after more than three days, and sometimes after more than 5 or 7 days. Calibration can be conducted by contacting an electrode with a solution of known (i.e., predetermined) chloride concentration and then calibrating the electrode with this solution (i.e., adjusting the settings of the electrode so that the concentration determined by the electrode matches the known concentration of the solution). Recalibration is indicated when, after a period of use, the electrode's performance is checked by contacting it with one or more solutions of known chloride concentration (preferably control solutions covering the clinical range of chloride concentration) and the measured concentration of the solution is different by two to three percent or more from the known concentration.

Flow Cells

Flow cell-type analyzers can be used to practice the present method. Such analyzers are known to the art, including those described in U.S. Pat. Nos. 5,130,095 and 5,833,925 (the contents of which are hereby incorporated by reference). The concentration of a number of ion species in solution, including lithium, calcium, sodium, potassium, chloride and carbonate (CO₂) can be measured with such flow cells.

Flow cell-type analyzers typically aspirate a fluid sample from a sample cup or compartment and deposit the sample into the flow cell, where it is mixed with reagent and/or diluent in a predetermined ratio. The flow cell includes various fluid sources in addition to such initial diluent in liquid communication with the flow cell to permit the measurement of ion species, such as an acid reagent and an internal reference fluid. A preferred instrument for use in a flow cell application of the present method is a SYNCHRON CX or a SYNCHRON LX clinical analyzer, which has the ability to conduct on-line reagent dilution and sample mixing through the use of a ratio pump (all SYNCHRON devices referred to herein are made by Beckman Coulter, Inc., 4300 N. Harbor Boulevard, Fullerton, Calif. 92834).

The sample fluid (sample mixed with appropriate diluent) is transported within the flow cell to a compartment which includes one or more ion selective electrodes for measuring the ion species. A reference electrode in electrical communication with the ion selective electrode or electrodes and with a reference fluid is also provided for a reference voltage measurement.

In the present method, a sample at a pH of greater than 5, usually at a pH of between about 6 and 8 (e.g., at about pH 7 in the case of most clinical samples), is first mixed with reagent or diluent, which is also usually at a pH of between 6 and 8. The mixture is then placed in contact with ion selective electrodes mounted in the flow cell, such as by transporting the mixture through a valve or duct (i.e., a pipe, tube or channel for conveying the mixture) to a compartment containing the electrodes. Such ion selective electrodes are preferably those adapted to take measurements in the sample pH range, such as ion selective electrodes for lithium, calcium, sodium, and/or potassium. A potential measurement is preferably taken with such ion selective electrodes simultaneously, though sequential measurements are possible. After measuring the sample with one or more ion selective electrodes at a pH of greater than 5, the pH of the sample and reagent solution mixture is then lowered to 5 or less and placed into contact with a silver chloride electrode, such as by transporting the sample through a second valve or duct to a compartment containing the silver chloride electrode. A potential measurement of the acidified sample solution is then taken with the silver chloride electrode. The concentration of another ion species such as carbonate (CO₂) can also be measured in the acidified sample fluid. Preferably, the flow cell performs the foregoing steps automatically, i.e. without operator input (other than providing operational instructions to the instrument operating the flow cell).

### EXAMPLE 1

### Analytical Response

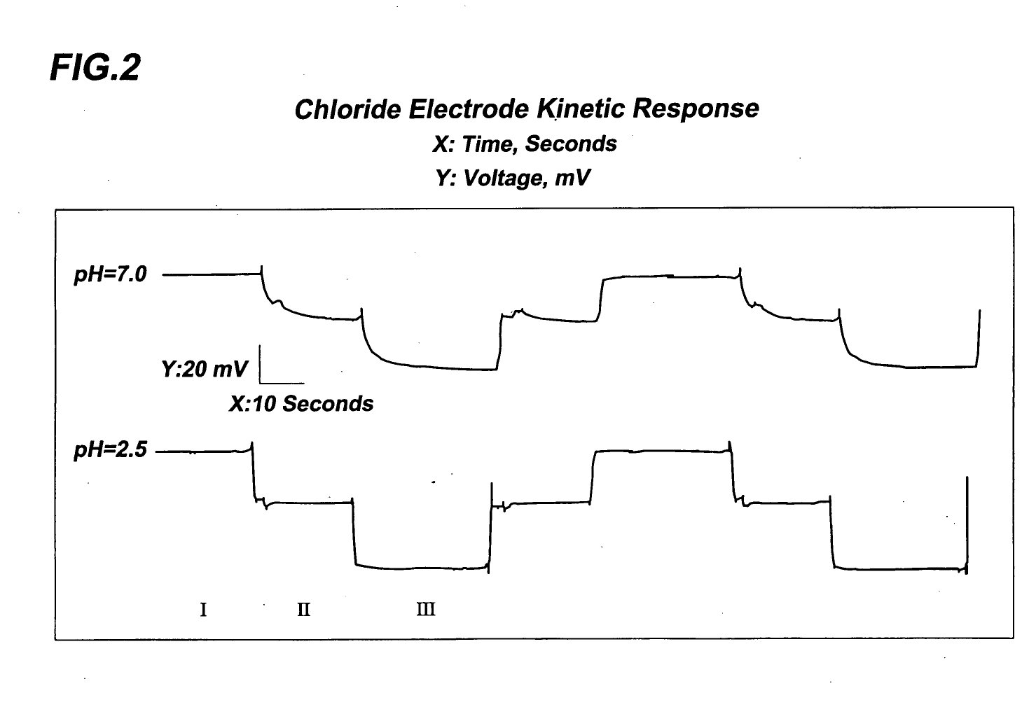

The analytical response of a solid state silver chloride electrode at neutral and acidic pH is detailed in FIGS. 1 and 2. FIG. 2 illustrates the kinetic response of a solid state silver chloride electrode in a SYNCHRON CX3 clinical analyzer when samples were measured at both pH 7.0 and pH 2.5. The samples were standard solutions available commercially and having the following chloride concentrations: sample I (high Cl⁻ concentration, approximately 400 mmol/L), sample II (Cl⁻ concentration of approximately 100 mmol/L), and sample III (low Cl⁻ concentration, approximately 15 mmol/L). When these samples were contacted with the electrode at pH 2.5, the measured change in potential occurred almost immediately, as shown by the near vertical line between the horizontal lines depicting the potentials of samples I and II (as well as the near vertical line between the potential measurements for samples II and III). By contrast, for the same measurements at pH 7, the electrode reached its steady state measurement values more slowly, as indicated by the more gently curving line between samples I and II in FIG. 2. Similarly curving lines can be seen in the transition from measuring sample II to measuring sample III at pH 7. The faster kinetic response at pH 2.5 enabled shorter measurement cycle time and higher throughput of samples being measured for chloride concentration.

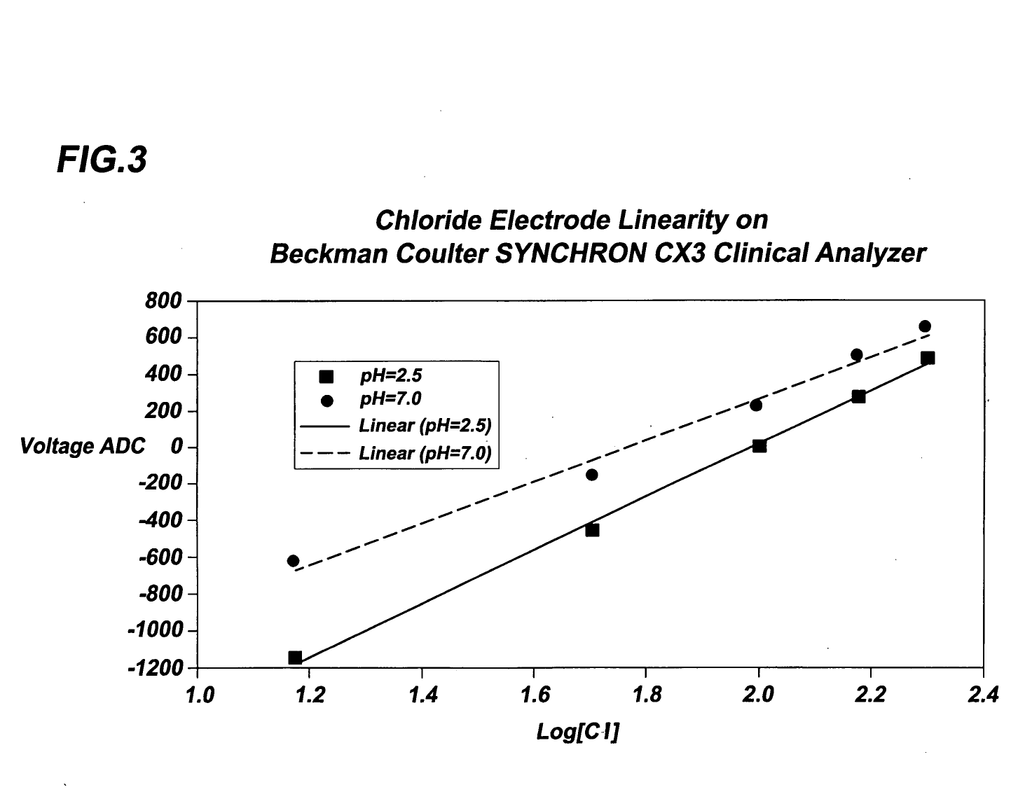

The linearity of measurements taken according to the present method, and the sensitivity of such measurements were likewise determined for samples I and III of Example 1 and for three other samples on a SYNCHRON CX3 clinical analyzer. FIG. 3 shows the voltage recorded for each such sample, plotted against the log of the chloride concentration. The measurements at pH 2.5 exhibited better linearity than those at pH 7.0, particularly at low chloride concentration (15 mmol/L). In addition, the slope of the line shown in FIG. 3, Δ(voltage)/Δ(log[Cl⁻]), is steeper at pH 2.5 than at pH 7.0, indicating less assay interference and higher sensitivity.

The within-run imprecision of chloride measurements at pH 2.5 was tested by measuring three samples twenty times each with a Synchron CX3. Precision is gauged by the size of the standard deviation and by the variance of coefficient (% CV) of the measurements. The results, summarized in Table 1 below, show good precision.

TABLE 1
Within-run Imprecision

| | Mean Concentration | Standard | Coefficient of |
|---|---|---|---|
| | mmol/L | Deviation | Variance |
| SAMPLE 1 | 77.22 | 0.42 | 0.54 |
| SAMPLE 2 | 96.2 | 0.55 | 0.57 |
| SAMPLE 3 | 113.9 | 0.67 | 0.59 |

### EXAMPLE 2

### Electrode Longevity

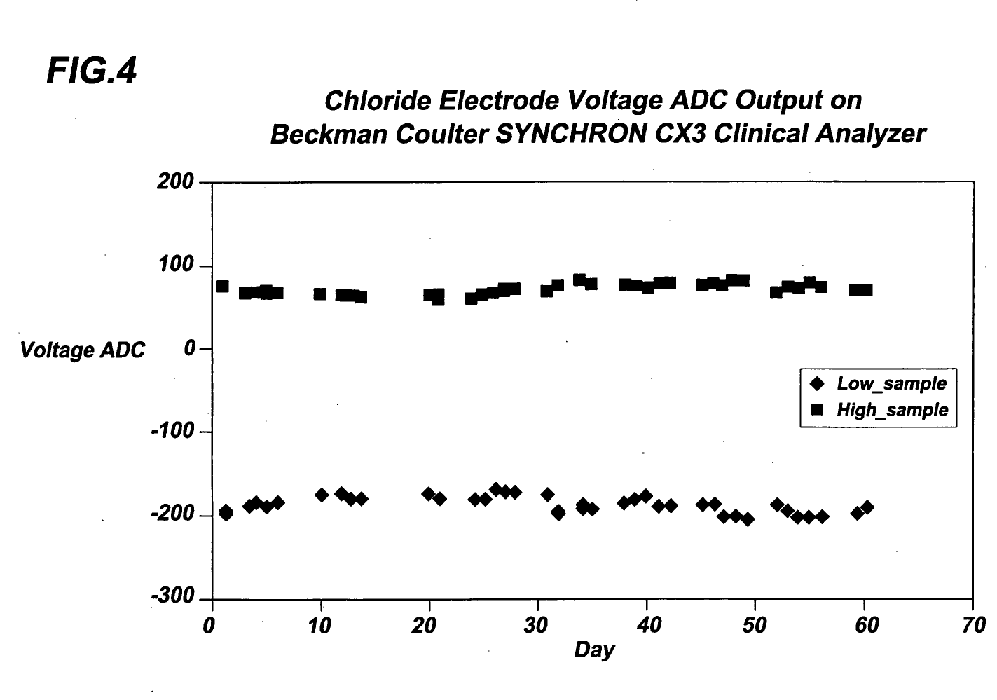

Tests were performed to determine the effect of low pH sample solutions on silver chloride electrode longevity. Chloride concentrations were measured for clinical samples from patients with a clinically low concentration of chloride (about 80 mmol/L) and with a high concentration (about 200 mmol/L) with a SYNCHRON CX3 clinical analyzer at pH 2.5 over a period of 60 days, during which time the AgCl electrode of the analyzer was in continuous contact with solutions at pH 2.5. FIG. 4 charts the electrode voltage measured for these samples over this period, and shows that the voltage output is very stable, i.e. there is no trend upward or downward in the voltage measurements. This indicates electrode longevity and robustness. When these measurements were taken at pH 7, the electrode exhibited deep surface erosion and had to be replaced in less than two months.

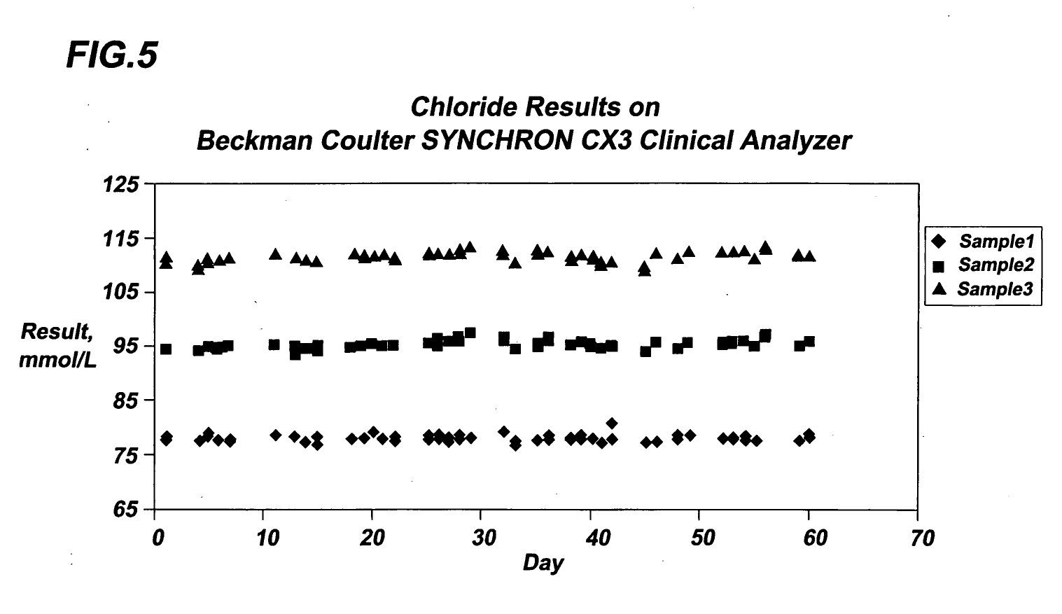

FIG. 5 likewise demonstrates the longevity of a silver chloride electrode when testing samples at low pH. Three control samples were tested at pH 2.5 with a SYNCHRON CX3 clinical analyzer over a period of 60 days, during which time the AgCl electrode of the analyzer was in continuous contact with solutions at pH 2.5. The results, plotted in FIG. 5, show consistent chloride concentration measurements over that period of time.

### EXAMPLE 3

### Electrode Calibration Frequency

A SYNCHRON CX3 clinical analyzer was used to measure the chloride concentration of several hundred patient samples, all at about pH 2.5, over the course of more than two weeks. No recalibration of the instrument was required over this time, that is, measurements of a control sample (also at low pH) over this period were within 3%. The same SYNCHRON CX3 clinical analyzer operated at pH 7 then measured the same samples and was found to require recalibration daily, i.e. after only one day of use.

### EXAMPLE 4

### Flow Cell Operation

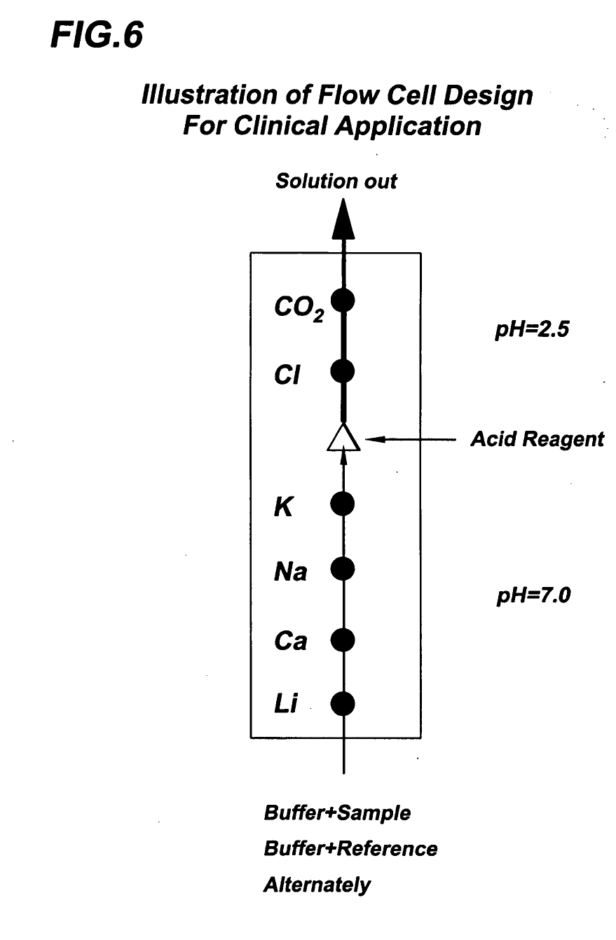

A flow cell design for use in the present method is illustrated in FIG. 6. Sample is mixed automatically by the analyzer with a buffer reagent at neutral pH (between about 6 and 8), and introduced into the flow cell, which in the illustrated embodiment comprises ion selective electrodes sensitive for lithium, calcium, sodium, and potassium. Acid reagent is introduced automatically after the potassium port to lower the pH of the sample solution for the chloride and CO₂ measurements. Following sample measurement and removal of the sample, a reference reagent and buffer reagent are introduced into the flow cell in order to flush the flow cell. Ion concentration measurements of the reference reagent are also taken. The reference and buffer reagents are likewise treated with the acid reagent to lower their pH's prior to contact with the silver chloride electrode.

The composition of reagents for use in such a flow cell is described in Table 2 below.

TABLE 2
Flow Cell Reagent Compositions

| | |
|---|---|
| Buffer Reagent | 0.16 M H₃PO₄ |
| | 0.30 M TRIS |
| | Other additives for optimal operation |
| Acid Reagent | 0.12 M H₂SO₄ |
| | Other additives for optimal operation |
| Reference Reagent | 0.01 M Citric Acid |
| | 0.12 M TRIS |
| | Salts (NaCl, KCl, LiCl, CaCl₂, NaHCO₃) |
| | Other additives for optimal operation |

In an alternative embodiment of a flow cell design, the sample is first diluted with an acidic reagent to form an acidified sample solution and measured with a silver chloride electrode, after which the pH of the sample solution is raised to over 5. However, this procedure is not preferred for samples which have an initial pH of over 5, as it involves the use of additional reagents first to lower the sample pH and then raise it following measurement with a silver chloride electrode.

Although the present invention has been discussed in considerable detail with reference to certain preferred embodiments, other embodiments are possible. Therefore, the scope of the appended claims should not be limited to the description of preferred embodiments contained in this disclosure. All references cited herein are incorporated by reference to their entirety.

What is claimed is:

1. A method of measuring the concentration of chloride ions in a sample solution initially having a pH greater than 5, comprising the steps of:
(a) adding an acidic reagent to the sample solution to lower the pH of the sample solution to 5 or less, thereby forming an acidified sample solution;
(b) contacting the acidified sample solution with an ion sensitive electrode comprising silver chloride; and
(c) measuring the electric potential of the acidified sample solution with the electrode.

2. The method of claim 1, wherein the electrode is a solid state silver chloride electrode.

3. The method of claim 1, additionally comprising the step of converting the electric potential measured in step (c) into chloride concentration for the sample solution.

4. The method of claim 1, wherein step (a) comprises lowering the pH of the sample to less than about 4.

5. The method of claim 4, wherein step (a) comprises lowering the pH of the sample to less than about 3.

6. The method of claim 5, wherein step (a) comprises lowering the pH of the sample to about 2.5.

7. The method of claim 1, wherein steps (a) and (b) are conducted simultaneously.

8. A method of measuring the concentration of chloride ions in a clinical sample, comprising the steps of:
(a) obtaining a solution comprising the clinical sample, wherein the solution has a pH of between about 6 and 8;
(b) adding an acidic reagent to the solution to lower the pH of the solution to 5 or less, thereby forming an acidified solution;
(c) contacting the acidified solution with an ion sensitive electrode comprising silver chloride; and
(d) measuring the electric potential of the acidified solution with the electrode.

9. The method of claim 8, additionally comprising the step of converting the electric potential measured in step (d) into chloride concentration for the sample solution.

10. The method of claim 8, wherein step (b) comprises lowering the pH of the solution to less than about 4.

11. The method of claim 10, wherein step (b) comprises lowering the pH of the solution to about 2.5.

12. A method of measuring the concentration of chloride ions in a plurality of sample solutions, comprising:
(a) contacting one of the plurality of sample solutions with an ion selective electrode comprising silver chloride;
(b) measuring the electric potential of the sample solution of step (a) with the electrode;
(c) removing the sample solution of step (a);
(d) contacting the electrode with one or more buffer solutions;
(e) repeating steps (a) through (d) for each of the remaining sample solutions over a period of more than 2 months, thereby measuring the concentration of chloride ions in each of the plurality of sample solutions; and
(f) maintaining substantially all of the plurality of sample solutions and the one or more buffer solutions at a pH of 5 or less so that the electrode decreases in sensitivity by less than 30 percent over the period of more than 2 months.

13. The method of claim 12, further comprising the steps of:
(i) testing the electrode for a drop in sensitivity; and
(ii) replacing the electrode after a drop in sensitivity of 30 percent or greater is detected.

14. The method of claim 12, comprising the steps prior to step (a) of:
providing one or more sample solutions initially having a pH greater than 5; and then
lowering the pH of the one or more sample solutions to pH 5 or less.

15. The method of claim 12, wherein the electrode is in contact with the sample solutions and the one or more buffer solutions for a period of more than 4 months, and wherein the electrode decreases in sensitivity by less than 30 percent during the period of more than 4 months.

16. The method of claim 12, wherein the electrode decreases in sensitivity by less than 20 percent during the period of more than 2 months.

17. A method of operating an ion selective electrode comprising silver chloride, comprising the steps of:
(a) calibrating the electrode;
(b) after step (a), measuring chloride concentration in one or more sample solutions having a pH of 5 or less by:
(i) contacting the electrode with the one or more sample solutions;
(ii) obtaining an electric potential measurement of the one or more sample solutions with the electrode to determine chloride concentration information; and
(iii) contacting the electrode with one or more buffer solutions having a pH of 5 or less, wherein the electrode is in substantially continuous contact with the one or more sample solutions and the one or more buffer solutions for a period of more than 3 days; and
(c) after step (b), evaluating the calibration of the electrode by:
(i) contacting the electrode with a solution having a known chloride concentration;
(ii) obtaining a chloride concentration measurement with the electrode, wherein the chloride concentration measurement obtained by the electrode is different by less than about 3 percent from the known chloride concentration of the solution having a known chloride concentration.

18. The method of claim 17, wherein step (a) comprises:
(i) contacting the electrode with a solution having a known chloride concentration;
(ii) obtaining a chloride concentration measurement with the electrode; and then
(iii) adjusting the electrode so that the chloride concentration measurement corresponds to the known chloride concentration of the solution.

19. The method of claim 17, comprising, prior to step (b), the steps of:
providing one or more sample solutions initially having a pH greater than 5; and then
lowering the pH of the one or more sample solutions to a pH of 5 or less.

20. The method of claim 17, wherein the electrode is in substantially continuous contact with the sample solution and the one or more buffer solutions for a period of more than 5 days, and wherein the concentration of the solution of known chloride concentration measured by the electrode changes by less than about 3 percent during the period of more than 5 days.

21. A method for measuring the concentration of ions in a sample solution with an analytical instrument, comprising:
(a) contacting the sample solution with an ion selective electrode in the instrument, wherein the sample solution is at a pH greater than 5, and wherein the ion selective electrode is adapted to measure the electric potential of an ionic species in the solution other than chloride;
(b) measuring the electric potential of the sample solution with the electrode;
(c) lowering the pH of the solution to 5 or less, thereby forming an acidified sample solution;
(d) contacting the acidified sample solution with an electrode comprising silver chloride; and
(e) measuring the electric potential of the acidified solution with the electrode comprising silver chloride.

22. The method of claim 21, wherein the ionic species in the solution other than chloride is selected from the group consisting of sodium, potassium, lithium, and calcium.

23. The method of claim 21, wherein the electrode comprising silver chloride is a solid state silver chloride electrode.

24. The method of claim 21, additionally comprising the step of converting the electric potential of the acidified sample solution measured in step (d) into chloride concentration information for the sample solution.

25. The method of claim 21, wherein step (c) comprises lowering the pH of the sample to less than about 4.

26. The method of claim 26, wherein step (c) comprises lowering the pH of the sample to about 2.5.

27. A system for measuring the concentration of chloride ions in a sample solution, comprising:
(a) an ion selective electrode adapted to measure the electric potential of an ionic species in the sample solution other than chloride at a pH greater than 5, the ion selective electrode being in communication with a first container for holding the sample solution;
(b) an ion selective electrode comprising silver chloride in communication with a second container for holding the sample solution;
(c) a first duct for conducting the sample solution from the first container to the second container;
(d) a container for holding an acidic reagent adapted to lower the pH of a solution initially at a pH greater than 5 to a pH of 5 or less; and
(e) a second duct for conducting the acidic reagent to the first duct or the second container.
